(19) United States
(12) Patent Application Publication
(10) Pub. No.: US 2003/0071769 A1
(43) Pub. Date: Apr. 17, 2003

(54) Method and apparatus for preventing plasma display screen burn-in

(76) Inventors: Dan Sullivan, Shoreview, MN (US); Randy Timo, Ramsey, MN (US)

Correspondence Address: Craig M. Gregersen, BRIGGS AND MORGAN, 2200 First National Bank Building, 332 Minnesota Street, Saint Paul, MN, 55101, US

(21) Appl. No.: 09/982,293

(22) Filed: Oct. 16, 2001

(51) Int. Cl. G09G 3/28; H04N 3/20

(52) U.S. Cl. 345/63

(57) ABSTRACT

The present invention provides method and apparatus for reducing or preventing the occurrence of burn-in in high-resolution plasma display screens. In a method in accord with the present invention, the luminosity of individual pixels can be altered according to predetermined criteria allowing the phosphor elements in the pixels to discharge according to predetermined criteria that inhibits the phenomenon of screen burn-in. In another embodiment of the present invention the luminosities of individual color phosphor elements forming the pixels can be changed according to predetermined criteria to allow the phosphors to discharge, thereby inhibiting burn-in from occurring.

### FIELD OF THE PRESENT INVENTION

The present invention relates in general to display screen “burn-in” and in particular to an improved method for the prevention of display screen burn-in of plasma displays.

### BACKGROUND OF THE PRESENT INVENTION

Electronic displays—such as television screens, computer monitors, liquid crystal displays, plasma displays, and other types of electronic displays—produce images according to different technologies. One technology involves the use of light producing elements called phosphors. In a color display, three phosphors capable of producing red, green and blue light are grouped together to form a picture element or pixel. Preferential activation of the individual phosphors in a pixel results in the pixel formed by those phosphors displaying a predetermine color at a predetermined luminosity. The pixels as a whole, then, form the image seen on the display screen.

Electronic displays generally and pixels in particular can experience a damaging phenomenon known generally as screen “burn-in.” The exact mechanism for the creation of “burn-in” in each display type varies because of the differing technology each type uses. Generally, however, it can be said that when a particular image is shown on a display for a long time, the screen can become damaged, leaving a “ghost” of the image on the screen that can be seen in some situations even when power to the display has been turned off.

For example, when the phosphor elements in a cathode ray tube—the “picture tube” of a television or computer monitors—or in a plasma display are activated by their respective technologies for a substantial length of time through the continuous display of the same image, the phosphor elements can be damaged or “burnt-in.” This “burn-in” substantially damages or limits the ability of the phosphors to respond to the electronic signals produced by the system for the display of subsequent images. An example of a common use of electronic displays in the past that resulted in burn-in was for displaying relatively unchanging images such as schedules for airlines. Another example is a computer monitor that was left on with the same, unchanging image on it for long periods of time.

The available technology for solving the problem of burn-in has advanced considerably. For example, in the computer industry, an initial response to the problem was the use of products such as screen savers. A screen saver is a software product that typically replaces an otherwise static screen image with a frequently changing image, thereby allowing the phosphors to discharge periodically. Some screen savers simply “blank” the screen to present no image rather than provide a changing image to the display screen.

Screen saver technology is useful, however, only where it is not important to continuously display the same image over a substantial time period. Thus, screen savers obviously are not a solution to the problem of displaying schedules for airlines or the like. Because of this limitation, the problem of burn-in has also been attacked by brute force approaches such as reducing the overall display luminosity or by moving the displayed image itself horizontally, vertically, or both, about the screen according to predetermined criteria, both of which methods can result in an adverse effect on image quality. The first of these approaches has the disadvantage of making the displayed information harder to see, which is hardly a desirable result for an advertiser relying on the information reaching potential customers. The second approach also has the disadvantage of randomly shifting the image pattern without necessarily achieving the desired discharge of all of the pixels. In addition, it is ineffective where a substantial portion of the screen is one color or shade. In the latter circumstance, simply shifting the image may still result in pixels displaying the same color or shade, the color white, for example, after the shift that they had been displaying before the shift of the image position.

Other methods exist for preventing burn-in, but they typically rely on some degree of randomization in the method of pixel discharge. Thus, these methods cannot guarantee that a particular individual phosphor will be discharged and therefore not subjected to periods of unaltering intensity.

Due to improved technology in the manufacture of computer CRTs, screen savers and other methods of preventing burn-in are generally unneeded today for those types of display devices. Nevertheless, even though modern manufacturing techniques and materials have substantially eliminated the problem of screen burn-in with CRT displays, burn-in remains a potential problem with plasma display screens, which are increasingly a valuable percentage of the digital display market. This market includes, among other usages, point of sale advertising displays in stores where a single advertisement or brand name may be displayed for lengthy periods of time.

Burn-in remains a problem for plasma displays because a plasma display phosphor element needs to be discharged periodically to maintain its ability to emit light. An additional, associated, problem that makes burn-in a problem with plasma displays is that a phosphor element's ability to emit light decreases with increasing age. For plasma displays, a burn-in situation occurs when a phosphor is on longer than other phosphors, and so become less able to provide light vis-à-vis its neighbors. The result is the appearance on the display of a permanent “shadow image” or ghost of the text or logo. Once this occurs, the condition can not be undone. Preventing plasma screen burn-in, then, requires that each phosphor be allowed to discharge and that the phosphor intensity be cycled so that the phosphors age uniformly across the display screen.

It would be desirable to have an apparatus and method for the substantial prevention of the occurrence of plasma display screen burn-in that was not subject to the foregoing disadvantages of the prior art, including but not limited to significantly altering the appearance of a displayed image.

### SUMMARY OF THE PRESENT INVENTION

It is an object of the present invention to provide a new and improved apparatus and method of preventing plasma display screen burn-in that is not subject to the deficiencies of the prior art.

It is a further object of the present invention to provide a new and improved apparatus and method for preventing plasma display screen burn-in by selectively controlling the luminosity of individual screen pixels according to a predetermined criteria.

It is another object of the present invention to provide a new and improved method of preventing plasma display screen burn-in by altering the color balance of individual phosphors of screen pixels chosen according to predetermined criteria.

The present invention provides apparatus and method for substantially preventing screen burn-in in high-resolution plasma display screens without affecting the perceived quality of the displayed image. For the purposes of this invention, a high-resolution display will be defined as a display having a resolution of at least 640×480, where the first number represents the number of pixels in a horizontal line on the screen and the second indicates the number of lines of pixels on the screen. In a method in accord with the present invention, the color balance of individual screen pixels is selectively altered. In one embodiment of the present invention the color balance is altered while keeping the luminosity of the pixel at its intended level. In another embodiment of the present invention, the color balance is altered while reducing the luminosity of the pixel below its intended level. The particular pixels of a display screen that are controllably altered according to the present invention can be randomly chosen according to predetermined criteria. In yet another method in accord with the present invention, the luminosity of any pixel selected according to predetermined criteria can be dimmed according to preselected criteria in situations where a frame buffer is unavailable for use.

The foregoing objects of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIGS. 1a and 1b illustrates a plasma display screen in schematic plan views.

FIG. 2 is a flow chart illustrating a method of substantially preventing plasma display screen burn-in in accord with the present invention.

FIG. 3 is a flow chart illustrating a method of substantially preventing plasma display screen burn-in in accord with the present invention wherein the luminosity of the pixel as a whole is reduced according to predetermined criteria and wherein the luminosity of each phosphor is reduced uniformly.

FIG. 4 is a flow chart illustrating a method of substantially preventing plasma display screen burn-in in accord with the present invention wherein the luminosity of individual phosphors is reduced according to predetermined criteria without increasing the luminosity of the remaining phosphors such that the total pixel luminosity is reduced.

FIG. 5 is a flow chart of illustrating a method of substantially preventing plasma display screen burn-in in accord with the present invention wherein the luminosity of individual phosphors is reduced according to predetermined criteria while the total pixel luminosity remains at its intended level through an increase in the luminosity of the other phosphors forming a pixel.

FIGS. 6a and 6b illustrate implementation of the present invention in a computer or like device with a display controller including a frame buffer.

FIG. 7 illustrates apparatus and method for implementing the present invention with a stand alone device.

### DETAILED DESCRIPTION OF THE PREFERRED EMBODIMENT

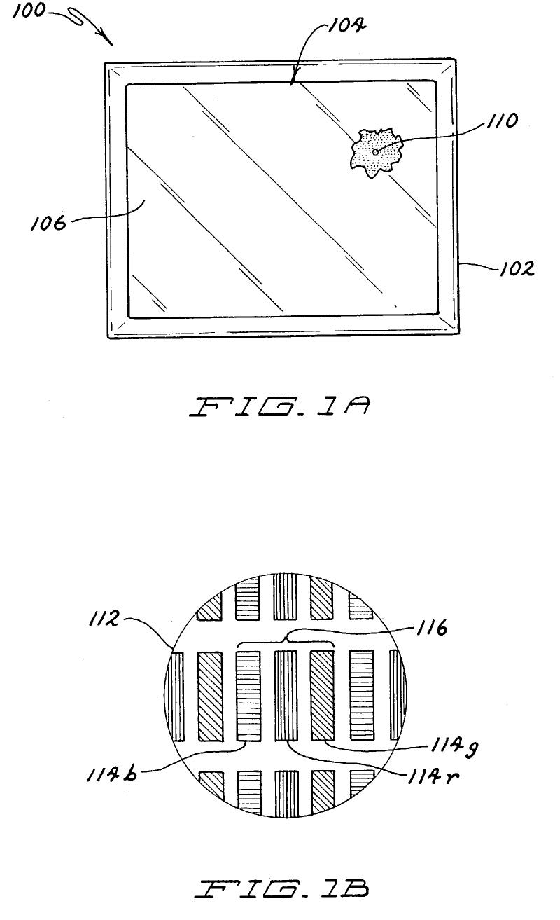

FIGS. 1a and 1b illustrate a plasma display screen of the type in which the present invention may be advantageously utilized. The principles of operation of a plasma display screen are well-known and can be found in many references and on many websites.

Referring to FIGS. 1a and 1b, a plasma display 100 is shown in a side elevation view. Display 100 typically comprises a housing 102 and a flat panel screen 104 including a transparent front layer or substrate 106, usually manufactured today from glass. Also highlighted in FIG. 1a is an area 110 of the screen 104, shown in more detail in FIG. 1b. That is, area 110 is shown enlarged at 112. As seen in the Figure, the screen 104 comprises an XY grid of rows and columns of phosphor elements 114, with phosphor elements 114r, 114g, and 114b capable of producing a red, green, or blue colored light, respectively. A picture element or pixel 116 is formed by one each of the red, green, and blue phosphor elements 114r, 114g, and 114b, respectively. Selective activation of the phosphors 114r, 114g, and 114b will result in a pixel 116 emitting a particular color at a particular luminosity.

With the foregoing generalized understanding of a plasma display screen, the present invention can be described. The present invention contemplates implementation by direct manipulation of the graphics system that generates the image shown on the display. The present invention can also be implemented in a stand-alone device wherein the video signal is intercepted, manipulated, and regenerated for presentation to the plasma display by the hardware in the standalone device.

Among the parameters affecting the image quality produced by a plasma display are the resolution and the ability of the display to present color variations. The resolution of a display screen is usually determined by the number of pixels that can be displayed on the screen at one time. Screen resolution is usually expressed as a pair of numbers, such as 640×480 with, as previously noted, the first number representing the number of pixels in each of the horizontally extending rows and the second representing the number of lines of pixels on the screen; the pixels thus form an XY array. As the screen resolution becomes greater, the individual pixels become smaller. As the pixels become smaller, the ability of a person to resolve individual pixels diminishes and disappears or nearly disappears at typical viewing distances. Thus, altering the luminosity of individual pixels generally will not affect the overall quality of a displayed image as perceived by a typical observer of a plasma display.

As to color sensitivity, the human visual system color sensitivity is well known after having been established in previous published experiments. To summarize, while the human eye is remarkably sensitive, it is unable to perceive color in fine detail. Thus, large color variations from pixel to pixel cannot be perceived by the human eye, particularly at the typical viewing distance for a plasma display. The plasma displays currently manufactured are capable of routinely displaying several million colors. Thus, even large alterations in the displayed colors can be made without being detected by the human eye by altering the luminosity of individual phosphors.

The luminosity L of a color display pixel for any given displayed image is governed by a well known equation:

aR+bG+cB=L,

where A, B, and C are coefficients such that a+b+c=1 and where R, G, and B are the individual luminosities of the red, green and blue phosphors, respectively. As R, G, and B change, the color displayed by the pixel changes. This equation thus makes clear that pixel luminosity is a function of the summed luminosities of the individual phosphors.

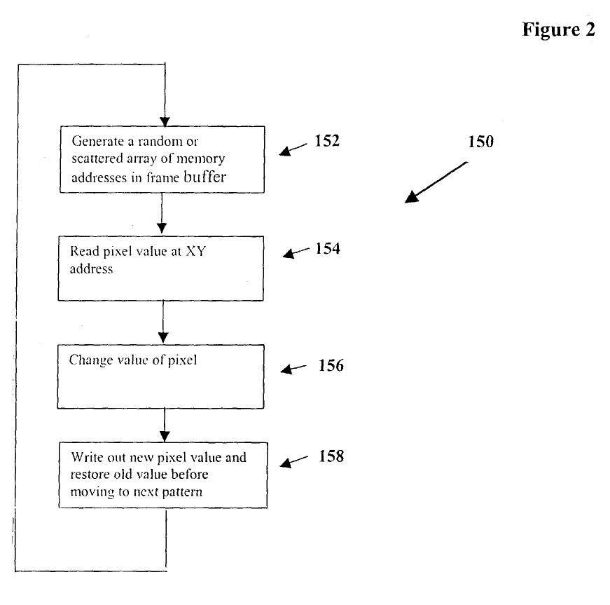

Referring now to FIGS. 2-7 the present invention will now be more fully described. The present invention as described hereafter contemplates the manipulation of the luminosity values of individual pixels in an XY array that is representative of the final displayed image. The present invention thus relies on the fact that a generated XY array is representative of the XY array of pixels forming the plasma display. A frame buffer is an array of pixel values that is periodically transferred to the plasma screen. Presumably, for most applications, the electronics driving any particular display will be capable of determining the state of each pixel in the frame buffer memory and thus the state of the phosphor elements corresponding to each pixel can be controlled by changing the pixel value. A one-to-one correspondence between display screen pixels and the frame buffer XY pixel array representation is not required by the present invention because the image to be displayed may be scaled by the various electronics integrated into the display hardware by any particular manufacturer. By way of example, if desired, all of the pixels in the frame buffer could be forced to a black level, thus discharging all of the phosphor elements in the display, even though the image may have been arbitrarily scaled.

FIG. 2 illustrates a method 150 for preventing plasma display screen burn-in in accord with the present invention. Generally, an array of XY memory addresses will be generated in a frame buffer associated with a plasma display screen, as indicated at 152. This array of addresses may be ordered or it may be randomly generated. In the first case of an ordered array, the addresses may be distributed across the display as desired. In the second case where the addresses are randomly generated, the addresses will represent pixels scattered across the display. The pixel value at each associated XY address will then be determined by the plasma display screen's associated electronics as indicated at 154. This value may be simply the pixel luminosity or it may include the individual phosphor luminosity values, R, G, and B. After reading each pixel value at 154, the value of the pixels will be temporarily changed according to predetermined criteria as indicated at 156. This value change may be to the pixel's total luminosity L or to the luminosities of the individual phosphors a, b, and c. This value change should be sufficient enough to allow the selected pixel phosphors, whether all of them in a pixel or one or two, to discharge. After the value of the pixels are changed at 156, the temporary pixel values will be written out of the frame buffer and the old pixel value will be restored at 158, all before generating a new pattern of memory addresses at 152.

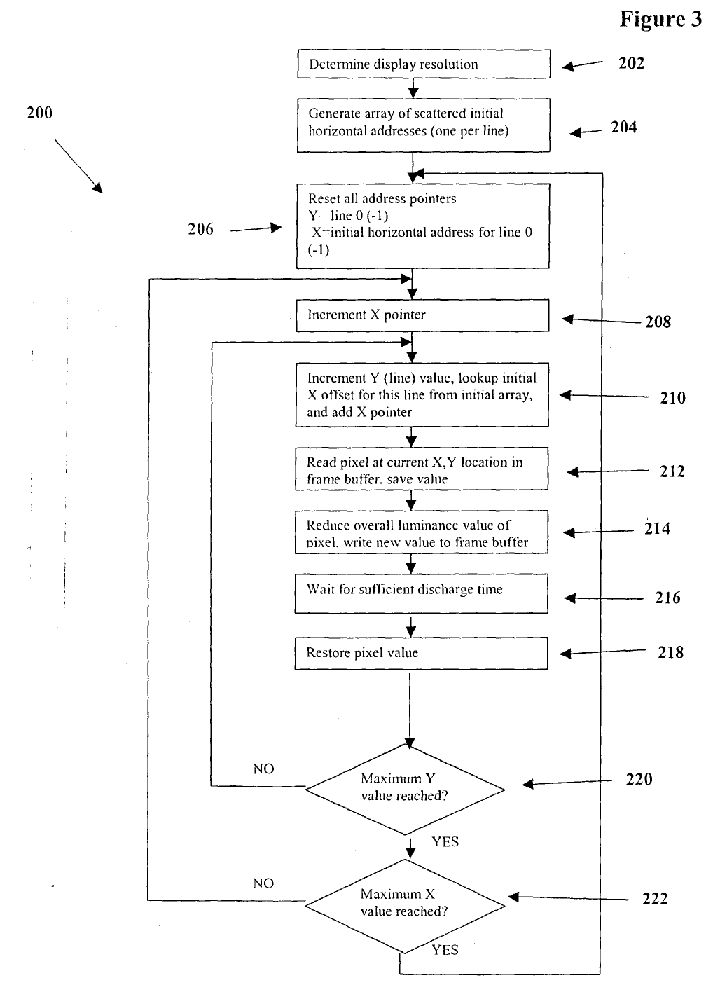

A more detailed description of a method of preventing plasma display screen burn-in 200 is illustrated in FIG. 3. The method described hereafter is appropriate for gray scale or text applications. In general, this method prevents burn-in by affecting pixel luminosity L without affecting the luminosity coefficients a, b, and c. That is, the method does not affect the ratio that each phosphor contributes to the total pixel luminosity L. As shown in the Figure, the resolution of the plasma display screen will be determined at 202. Screen resolution can now be relatively easily changed and because the present invention is intended for use on plasma display screens having a resolution of at least 640×480, the resolution of the screen will first be ascertained to determine if the present invention will be implemented thereon. After the screen resolution has been determined and found to be sufficiently high for purposes of the present invention, an array of scattered horizontal addresses can be generated, for example, at least one address for each pixel row or line of screen resolution as at 204. Following the address generation at 204, all address pointers will be reset as at 206. Thus, the address pointer will be set to the Y value to line 0 vertically and the X value of the address to the initial horizontal address generated at 204 for line 0.

The X address pointer will then be incremented as at 208, followed by incrementing the Y address pointer at 210. After incrementing the Y pointer, the initial X address or offset for this line will be looked up in the generated array (at 204) and the X pointer will be added thereto to arrive at an XY address for a particular pixel on the display. Subsequently, the pixel luminosity value for that XY address will be read from the frame buffer and that value will be saved as at 212.

After the luminosity value has been saved at 212, the pixel at the XY address will be discharged. To do so, the pixel will be commanded to reduce its luminosity as at 214 with the reduced luminosity value being written to the frame buffer. This reduced luminosity will be maintained for a time sufficient for the pixel to discharge as at 216. Following the discharge of the pixel, the luminosity value of the pixel stored at 212 will be restored at 218.

After the luminosity of the pixel is restored at 218 a check will then be performed to determine if the maximum number of horizontal scan lines has been reached by comparing the incremented Y value with the number of scan lines or lines of pixels on the particular display at 220. If the maximum has not been reached, then the routine will return to step 210 and increment the Y line value again. In this way, then, a particular vertical line of pixels on the display screen will be selectively discharged. If the maximum has Y value has been reached, then a check will be made at 222 to determine if the maximum X value has been reached. If not, then the routine will return to step 208 and the next generated horizontal X address will be selected as at step 208 and the routine will be repeated for the new X address. If the maximum X address has been reached, then the routine will return to step 206 and the pixel discharge routine will begin anew.

The foregoing method, then, will selectively discharge all of the pixels on the display. The total time for the entire screen to be discharged once can be determined as deemed desirable to prevent burn-in.

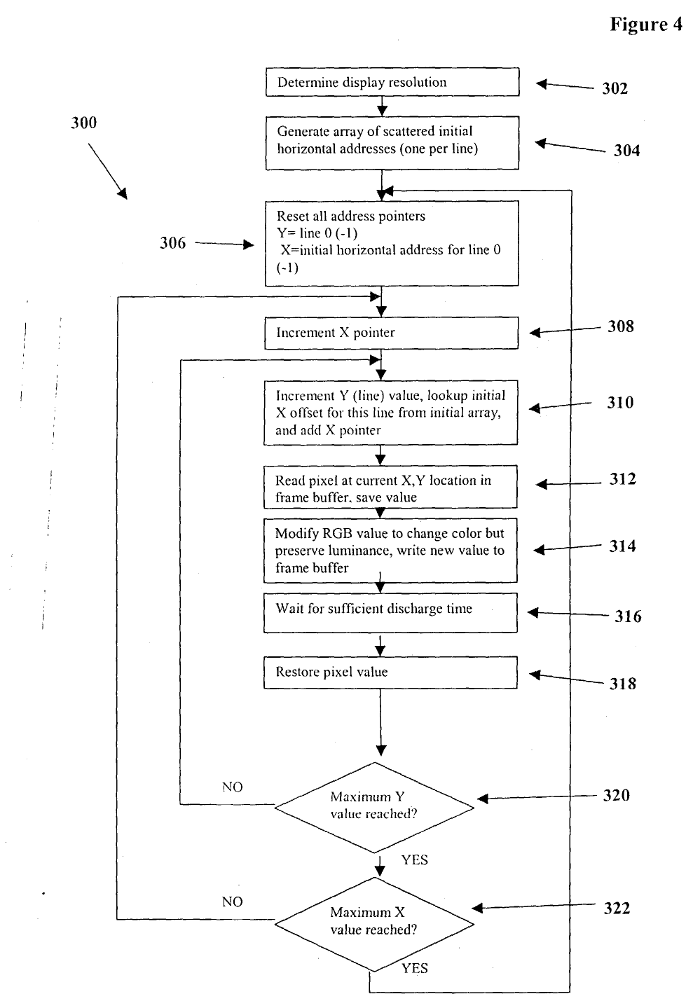

FIG. 4 illustrates an alternative method 300 for preventing plasma display burn-in. Many of the steps in this method are similar to that of the method illustrated in FIG. 3. In this method, the color value of the pixel is affected. In a first step in such a method 300, the screen resolution will be determined as at 302 for the same reasons as given with respect to FIG. 3. An array of scattered initial horizontal addresses will be generated as at 304, with at least one address being generated per horizontal line of resolution. Following the address generation at 304, all address pointers will be reset as at 306. Thus, the address pointer will be set to the Y value to line 0 vertically and the X value of the address to the initial horizontal address generated at 304 for line 0.

The X address pointer will then be incremented as at 308, followed by incrementing the Y address pointer at 310. After incrementing the Y pointer, the initial X address or offset for this line will be looked up in the generated array (at 304) and the X pointer will be added thereto to arrive at an XY address for a particular pixel on the display. Subsequently, the pixel luminosity value for that XY address will be read from the frame buffer and that value will be saved as at 312.

After the pixel luminosity value for that particular XY address has been saved at 312, the color of the pixel will be modified by modifying the one or more of the luminosities of the phosphors making up the pixel at 314. Thus, the R, G, and or B phosphor values will be altered, while maintaining the total luminosity L of the pixel. In this way, the individual phosphors can be discharged without affecting the pixel luminosity. Once again, this new pixel state will be maintained a sufficient time for the phosphors to discharge at 316 and then the original pixel phosphor values will be restored at 318.

After the phosphor values of the pixel are restored at 318 a check will then be performed to determine if the maximum number of horizontal scan lines has been reached by comparing the incremented Y value with the number of scan lines or lines of pixels on the particular display at 320. If the maximum has not been reached, then the routine will return to step 310 and increment the Y line value again. In this way, then, a particular vertical line of pixels on the display screen will be selectively discharged. If the maximum has Y value has been reached, then a check will be made at 322 to determine if the maximum X value has been reached. If not, then the routine will return to step 308 and the next generated horizontal X address will be selected as at step 308 and the routine will be repeated for the new X address. If the maximum X address has been reached, then the routine will return to step 306 and the pixel discharge routine will begin anew.

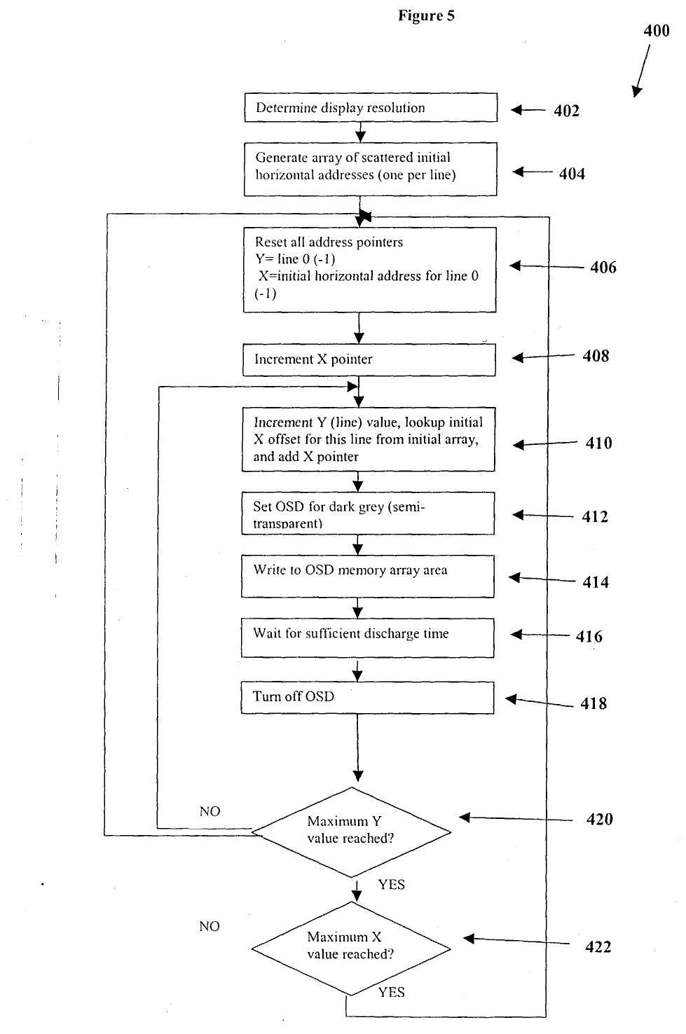

FIG. 5 illustrates another alternative method for prevention of plasma display burn-in. FIG. 5 is proposed for the situation where there is no frame buffer available or use of it is impractical for this purpose. An example where such a situation may arise are display devices that receive and process compressed data files before displaying the files. An example of such files are those produced according to standards promulgated by the Moving Picture Experts Group, which has developed standards for digital video and digital audio compression. Such data files are typically referred to as MPEG files. More specifically, most decoders of MPEG2 files will include an on-screen display that can produce an image that overlays an existing image already being displayed. This overlay image will have a one-to-one correspondence with each pixel in the image. In addition, the overlay can be used to dim pixels by the inclusion of an element of transparency or it can be set to a predetermined number of opaque colors.

With specific reference to FIG. 5, a method 400 of prevention of plasma display screen burn-in is illustrated. Several of the steps in FIG. 5 are similar to or identical to the steps shown in FIGS. 3 and 4. Thus, the screen resolution will be determined as at 402 for the same reasons as given with respect to FIG. 3. An array of scattered initial horizontal addresses will be generated at 404, with at least one address being generated per horizontal line of resolution. Following the address generation at 404, all address pointers will be reset as at 406. Thus, the address pointer will be set to the Y value to line 0 vertically and the X value of the address to the initial horizontal address generated at 404 for line 0.

The X address pointer will then be incremented as at 408, followed by incrementing the Y address pointer at 410. After incrementing the Y pointer, the initial X address or offset for this line will be looked up in the generated array (at 404) and the X pointer will be added thereto to arrive at an XY address for a particular pixel on the display. Subsequently, the on-screen display (OSD) image will be set for a dark gray or semitransparent color at 412. This OSD image will then be written to the memory array at 414, thus providing a one-to-one pixel dimming in that area of the plasma display where the OSD image is disposed. This OSD image will be maintained for a time period sufficient to allow the pixels to discharge as at 416 and then the OSD image will be turned off, as at 418, allowing the pixel to return to its intended luminosity.

After the luminosity values of the pixel are restored at 418 a check will then be performed to determine if the maximum number of horizontal scan lines has been reached by comparing the incremented Y value with the number of scan lines or lines of pixels on the particular display at 420. If the maximum has not been reached, then the routine will return to step 410 and increment the Y line value again. In this way, then, a particular vertical line of pixels on the display screen will be selectively discharged. If the maximum has Y value has been reached, then a check will be made at 422 to determine if the maximum X value has been reached. If not, then the routine will return to step 408 and the next generated horizontal X address will be selected as at step 408 and the routine will be repeated for the new X address. If the maximum X address has been reached, then the routine will return to step 406 and the pixel discharge routine will begin anew.

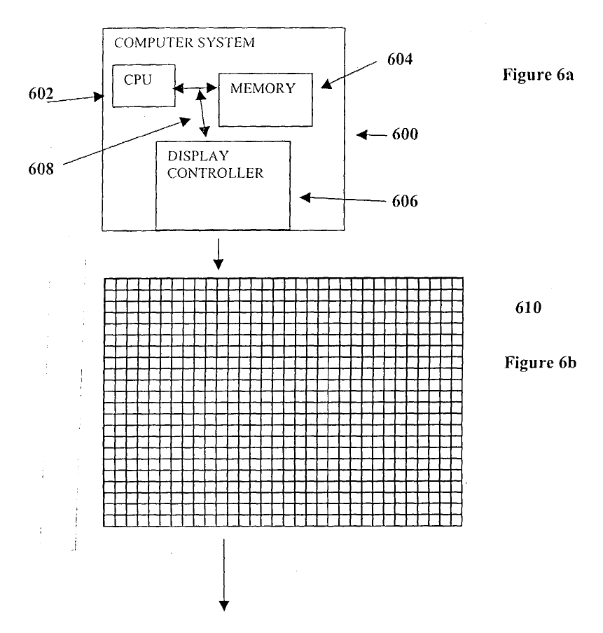

Referring now to FIG. 6, the implementation of the foregoing methods by way of a computer will be further explained relative to the schematic drawing thereof. Generally speaking, a computer or computer system 600 can be said to comprise a central processing unit 602, a memory 604, and a display controller 606 useful in controlling the display used in association with system 600. The CPU 602, memory 604, and controller 606 will communicate with each other over the appropriate communication lines 608. The controller 608, or an on-screen display, will include at XY array 610 representative of the XY array of pixels forming the display screen. This array 610 will be manipulated as previously described to create a distributed pattern of altered pixels, which will then be provided to the display screen, such as display screen 100. This array of altered pixels will then allow selected pixels to discharge, thus preventing screen burn-in.

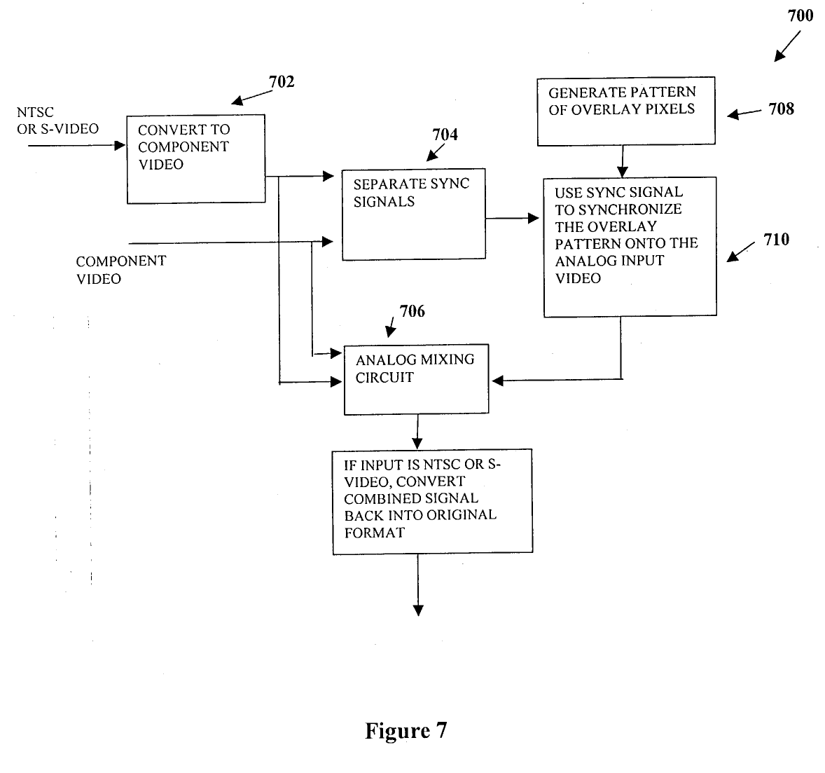

FIG. 7 illustrates an implementation 700 of the present invention in a stand-alone device. Thus, the video input signal of the image to be displayed may take the form of a signal compatible with the component or device used to display an image or it may take the form an NTSC signal in accord with the protocol of the National Television Standards Committee or an S-video signal. Where the signal takes the form of and NTSC or S-video signal, it will be converted to an analog video signal by an appropriate hardware converter or software implementation as indicated at 702. After conversion of the NTSC or S-video signal, the converted analog signal will be provided to a signal generator 704 that generates a synchronizing signal and to analog mixing circuit 706. Where the signal takes the form initially of an analog component video signal, it can be supplied directly to both the synchronizing signal generator 704 and the analog mixing circuit 706.

In addition, an appropriate device, such as a microprocessor, will generate the predetermined pattern of overlay pixels according to the foregoing methods at 708, which will then be synchronized with the signal provided by the synchronizing signal generation step 704 at 710. The synchronized pixel array overlay signal will then be provided to the analog mixing circuit 706 and combined. The mixing circuit 706 will then output an analog signal that will be supplied to the display. Where the original signal takes the form of an NTSC or S-video signal, the mixing circuit will supply the output signal to an appropriate converter at 712 to convert the signal back into the NTSC or S-video format, which in turn will be provided to the display.

The present invention having thus been described, other modifications, alterations, or substitutions may now suggest themselves to those skilled in the art, all of which are within the spirit and scope of the present invention. It is therefore intended that the present invention be limited only by the scope of the attached claims below.

What is claimed is:

1. A method for preventing burn-in in a plasma display screen having an XY array of pixels providing a screen resolution of 640×480 dpi or greater, wherein said method does not significantly alter the appearance of the image displayed for an observer of the display screen, said method comprising:
(a) selecting a horizontal pixel address;
(b) reducing the luminosity of the pixel at the selected horizontal pixel address for each of the horizontal line of pixels;
(c) repeating steps (a) and (b) for each horizontal pixel address.

2. The method of claim 1 and further including:
(d) determining the screen resolution to be at least 640×480 dpi

3. The method of claim 1 wherein the plasma display provides gray scale or text applications and is controlled by electronics including a frame buffer including an XY representation of the pixels in the display and said method further includes:
(d) generating a list of one horizontal screen address per line;
(e) resetting all address pointers in the frame buffer;
(f) incrementing the X address pointer of the frame buffer;
(g) incrementing the Y address pointer of the frame buffer;
(h) looking up the X address offset for the line representative of the Y address provided by step (g) and adding the X pointer to the X address to provide an XY address for a pixel in the display;
(i) reading the pixel luminosity value for the XY address determined in step (h) and saving that pixel luminosity value;
(j) discharging the pixel at the XY address determined in step (h);
(k) restoring the saved pixel luminosity value to the pixel at the XY address determined in step (h); and
(l) repeating steps (a) through (k) for each generated horizontal address and each horizontal line of pixels.

4. The method of claim 3 wherein said step of discharging includes reducing the luminosity of the pixel at the XY address determined in step (h) for a time sufficient for the pixel to discharge.

5. The method of claim 1 wherein the plasma display includes red, green, and blue phosphor elements and is controlled by electronics including a frame buffer including an XY representation of the pixels in the display and said method further includes:
(d) generating a list of one horizontal screen address per line;
(e) resetting all address pointers in the frame buffer;
(f) incrementing the X address pointer of the frame buffer;
(g) incrementing the Y address pointer of the frame buffer;
(h) looking up the X address offset for the line representative of the Y address provided by step (g) and adding the X pointer to the X address to provide an XY address for a pixel in the display;
(i) reading the pixel luminosity value for the XY address determined in step (h) and saving that pixel luminosity value;
(j) discharging the color pixel at the XY address determined in step (h);
(k) restoring the saved pixel luminosity value to the pixel at the XY address determined in step (h); and
(l) repeating steps (a) through (k) for each generated horizontal address and each horizontal line of pixels.

6. The method of claim 5 wherein said step of discharging the color pixel in step (j) includes modifying at least one of the luminosities of the phosphor elements making up the pixel.

7. The method of claim 6 wherein said step of modifying at least one of the luminosities of the phosphor elements includes maintaining the total luminosity of the pixel.

8. The method of claim 1 wherein the plasma display includes a memory and wherein the image provided to the plasma display is provided by an on screen display and said method further includes:
(d) generating a list of one horizontal screen address per line;
(e) resetting all address pointers in the frame buffer;
(f) incrementing the X address pointer of the frame buffer;
(g) incrementing the Y address pointer of the frame buffer;
(h) looking up the X address offset for the line representative of the Y address provided by step (g) and adding the X pointer to the X address to provide an XY address for a pixel in the display;
(i) set the corresponding pixel in the on screen display image to dark gray or semitransparent;
(j) write the on screen display pixel to memory;
(k) discharge the pixel at the XY address determined by step (h);
(l) return the pixel at the XY address determined by step (h) to its intended luminosity value; and
(m) repeating steps (a) through (l) for each generated horizontal address and each horizontal line of pixels.

9. The method of claim 1 and further including providing:
an input video signal;
a stand-alone device for providing a pattern of overlay pixels;
a means for providing a synchronizing signal; and
an analog mixing circuit,
and wherein:
the stand alone device provides an overlay pattern of the selected horizontal address;
the input video signal is provided the analog mixing circuit and to the synchronizing means to produce a synchronized video signal for synchronizing the overlay pattern of pixels with the input video signal to produce a synchronized pattern signal;
the analog mixing circuit receives the input video signal and the synchronized pattern signal and provides an output signal for display to the plasma display.

10. The method of claim 9 wherein the input video signal is an NTSC or s-video signal and said method further including converting the NTSC or s-video signal into an analog video signal.

11. The method of claim 10 wherein the output video signal is converted back to the original format of the input video signal for output to the plasma display.
